(19) United States
(12) Patent Application Publication
(10) Pub. No.: US 2024/0016124 A1
(43) Pub. Date: Jan. 18, 2024

(54) ANIMAL EXCRETION COLLECTING DEVICE

(71) Applicant: David R Draper, Peru, IL (US)

(72) Inventor: David R Draper, Peru, IL (US)

(21) Appl. No.: 17/865,384

(22) Filed: Jul. 15, 2022

(51) Int. Cl. A01K 1/01

(52) U.S. Cl. CPC A01K 1/0107

(57) ABSTRACT

A collection device that is particularly suited for resiliently supporting a bag for the upright collection of excrement from an animal, such as a dog, by a user for subsequent disposal is presented. The device includes an elongated portion that extends between a first end and a second end. The first end includes a portion to facilitate holding the device, such as a handle. The handle is the terminal portion of the first end of the elongated portion formed as a loop and fastened to itself with a fastener. The elongated portion is configured to allow the user to remain standing for collection of the animal excrement as the animal is in the excreting position. A ring is attached to the second end of the elongated portion. The ring is configured to removably attach a bag thereto.

### FIELD OF THE INVENTION

This invention relates to collection of animal excretion devices. More particularly, it relates to collection of animal excretion devices not requiring the stooping of the collector.

### BACKGROUND

Dog droppings are one of the leading sources of coli (fecal coliforms) bacterial pollution, Toxocara Canis and Neospora caninum helminth parasite pollution. One gram of dog feces contains over 20,000,000 E. coli cells. While an individual animal's deposit of feces will not measurably affect the environment, the cumulative effect of thousands of dogs and cats in a metropolitan area can create serious problems due to contamination of soil and water supplies. The runoff from neglected pet waste contaminates water, creating health hazards for people, fish, ducks, etc.

There are different ways to pick up dog poop one of which is a pooper-scooper, or poop scoop. This is a device used to pick up animal feces from public places and yards, particularly those of dogs. Pooper-scooper devices often have a bag or bag attachment.

Poop bags are alternatives to pooper scoopers, and are simply a bag, usually turned inside out, to carry the feces to a proper disposal area. Sometimes, the person performing the cleanup is also known as the pooper-scooper.

With the current options available for picking up dog excrement, all require a human to come in close proximity of the excrement possibly becoming in contact with it. This is a huge health risk as noted above. Contactless disposal would be of the upmost importance for a healthy way of disposal.

Accordingly, and in light of the foregoing, it would be desirable to have an effortless way to pick up dog excrement without coming in contact with the waste. This device would have a long handle attached to an area containing a bag where the dog would go to the bathroom in. The area could be adjusted in different sizes depending on what is size needed. The device is configured to provide a sanitary and efficient manner to dispose of dog excrement.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an animal excrement collection device 10, according to the preferred embodiment of the present disclosure;

FIG. 2 is a side view of the animal excrement collection device 10 according to the preferred embodiment of the present disclosure;

FIG. 3 is a side view of the animal excrement collection device 10 according to the preferred embodiment of the present disclosure; and

FIG. 4 is a perspective view of the animal excrement collection device 10 in use according to the preferred embodiment of the present disclosure.

### DESCRIPTIVE KEY

10 collection device
12 elongated portion
13 fastener
14 first end
16 second end
18 handle
20 ring
22 opening
30 attachment mechanism
32 connector
40 bag
42 open end
43 rim
44 closed end
U user
D dog

### DESCRIPTION OF THE PREFERRED EMBODIMENTS

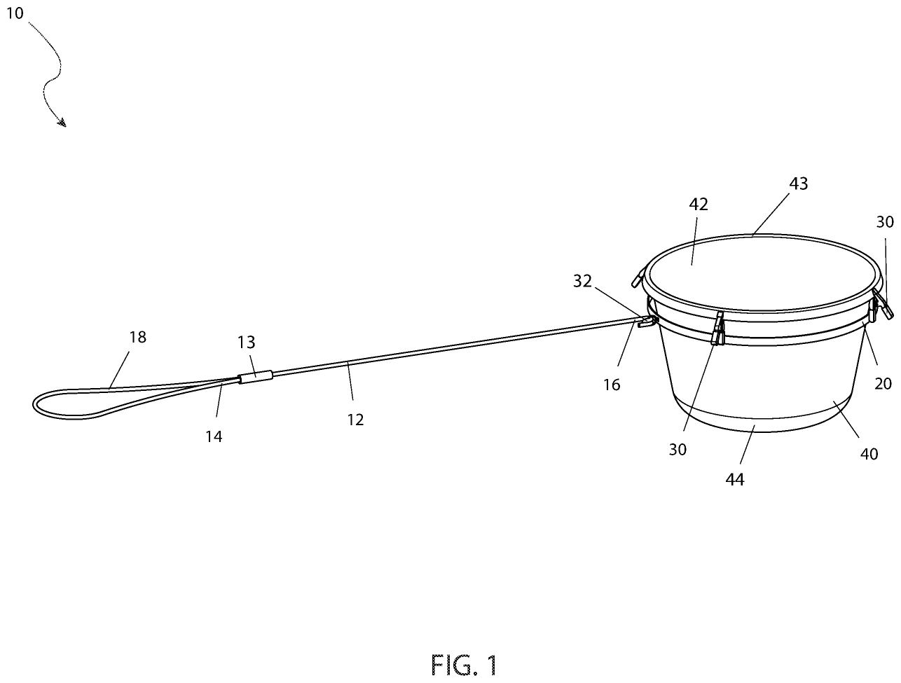

The best mode for carrying out the invention is presented in terms of its preferred embodiment, herein depicted within FIGS. 1 through 4. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### DETAILED DESCRIPTION OF THE FIGURES

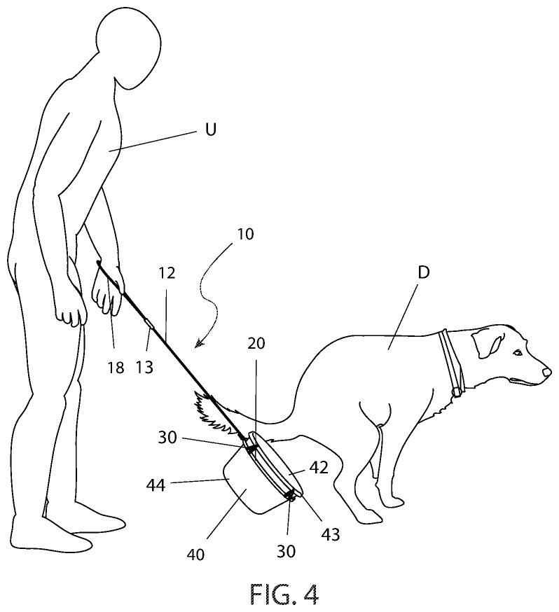

Referring now to FIG. 1, a perspective view of a collection device (herein also described as the “device”) 10 is described herein. As best seen in FIG. 4, the collection device 10 is particularly suited for resiliently supporting a bag 40 for the upright collection of excrement from an animal, such as a dog D, by a user U for subsequent disposal.

The device 10 includes an elongated portion 12 that extends between a first end 14 and a second end 16. The first end 14 includes a portion to facilitate holding the device 10, for example, a handle 18. The handle 18 can include various shapes configured to facilitate grabbing thereof. In some embodiments, the handle 18 may include various shapes, for example, oval, oblong, triangular, square, polygonal, irregular, uniform, non-uniform, variable, and/or tapered. In the exemplary embodiment, the handle 18 is the terminal portion of the first end 14 of the elongated portion 12 formed as a loop and fastened to itself with a fastener 13. In some embodiments, the elongated portion 12 may include materials such as, metal, plastic or other suitable material. The elongated portion 12 is configured to allow the user U to remain standing for collection of the animal excrement as the animal is in the excreting position. A ring 20 is attached to the second end 16 of the elongated portion. The ring 20 is configured to removably attach a bag 40 thereto.

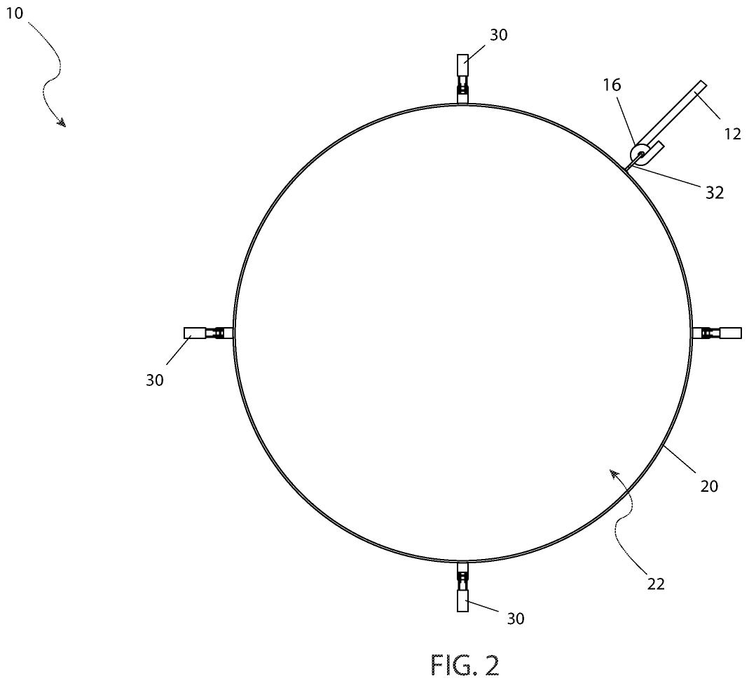

Referring now to FIG. 2, which illustrated a more detailed view of the ring 20, is disclosed. The ring 20 may include a spring material to provide some level of elasticity or ease of manipulation in order to facilitate connection of a collection element, such as the bag 40. The ring 20 forms an opening 22. In other embodiments, the ring 20 is adjustable so that the diameter of the ring 20, and thus the size of opening 22 can be raised or lowered.

Device 10 includes at least one (1) attachment mechanism 30, attached, affixed, or otherwise bonded to the ring 20. In some embodiments, the attachment mechanism 30 may include an integral connection, friction fit, pressure fit, interlocking engagement, mating engagement, dovetail connection, clips, barbs, tongue-in-groove or threaded. In the exemplary embodiment, the attachment mechanism 30 is a spring clip, wherein a portion thereof is affixed to the outer surface of the ring 20 such that the manipulatable jaws of the spring clip can be pivotably positioned as desired. In yet another exemplary embodiment, the attachment mechanism 30 comprises four (4) spring clips, equidistantly-spaced thereapart. A connector 32 is attached, affixed, or otherwise bonded to the outer surface of the ring 20, and can be generally shaped as a hook and can also be an extension of the ring 20 itself. The connector 32 is particularly configured to receive and secure the second end 16 of the elongated portion 12 thereto.

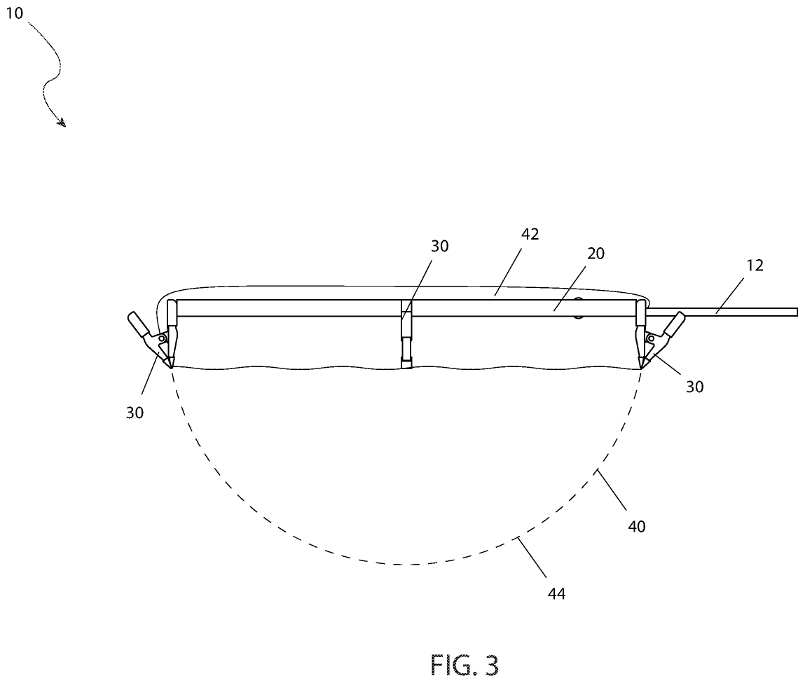

Referring to FIG. 3, the attachment mechanisms 30 are each configured to attach a collection element, for example, a bag 40 to the ring 20, as shown in FIG. 1. The bag 40 can include an open end 42 and a closed end 44. The bag 40 is preferably disposed fully within the opening 24 of the ring 20 such that the closed end 44 translates through the ring 20 and the open end 42 is wrapped around the ring 20. The bag 40 is attached to the ring 20 with the attachment mechanisms 30. Referring now back to FIG. 1, there may be some embodiments where the bag 40 has a reinforcing rim 43 that surrounds the open end 42. This rim 43 may provide a more stable surface for the attachment mechanism 30 to fasten to. The bag 40 can be plastic or paper or other suitable material to collect excrement in a sanitary manner.

### Operation of the Preferred Embodiment

The preferred embodiment of the present invention can be utilized by the common user U in a simple and effortless manner with little or no training. The device 10 would be constructed in general accordance with FIG. 1 through FIG. 4. The user U would procure the device 10 from conventional procurement channels. The user U would bring device 10 with a dog D to an area that the dog D would go to the bathroom. The user U would adjust the ring 20 if necessary to create the opening 22 to an appropriate size relative to the dog D. The user U would place a bag 40 within the opening 24 such that the closed end 44 translates through the ring 20. The open end 42 is wrapped over the ring 20. Other embodiments would provide for such a bag 40 that also incorporates a reinforcing rim 43. The attachment mechanisms 30 are positioned such that they all coincidentally or independently removably attach the outer perimeter of the bag 40, or to a reinforcing rim 43 of the bag 40 to the ring 20, as shown and described herein. As shown in FIG. 4, the user U holds the handle 18 and positions the ring 20 relative to the anus of the dog D when the dog D assumes a defecating position. As the dog D excretes, the excrement falls into the bag 40. The user U can then detach the bag 40 from ring 20 and dispose of the bag 40. The device 10 is configured to provide a sanitary and efficient manner to dispose of dog D or excrement, or the equivalent thereof.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A collection device for an upright collection of excrement of an animal, the collection device comprising:
an elongated portion, the elongated portion has a first end and a second end, wherein the first end is configured to be a handle;
a ring, the ring being coupled to the second end of the elongated portion; and
a bag, the bag coupled to the ring by a connector.

2. The collection device according to claim 1, wherein the ring is removably coupled to a bag by one or more attachment mechanisms.

3. The collection device according to claim 2, wherein the attachment mechanisms is an integral connection.

4. The collection device according to claim 2, wherein the attachment mechanisms is a friction fit.

5. The collection device according to claim 2, wherein the attachment mechanisms is a barb.

6. The collection device according to claim 2, wherein the attachment mechanisms is four (4) spring clips.

7. The collection device according to claim 6, wherein the spring clips are equal-distantly spaced around the ring.

8. The collection device according to claim 2, wherein the connector being bonded to the ring.

9. The collection device according to claim 1, wherein the bag is configured to be fully disposed with an opening of the ring.

10. The collection device according to claim 1, wherein the bag having a closed end, wherein the closed end of the bag translates through the ring.

11. The collection device according to claim 1, wherein the open end is wrapped around the ring.

12. The collection device according to claim 1, wherein the handle has a shape.

13. The collection device according to claim 12, wherein the shape of the handle is a loop.

14. The collection device according to claim 12, wherein the shape of the hand is oval.

15. The collection device according to claim 1, wherein the elongated portion is made of a metal material.

16. The collection device according to claim 1, wherein the elongated portion is made of a plastic material.

17. The collection device according to claim 1, wherein the ring has a diameter,

18. The collection device according to claim 17, wherein the diameter of the ring is adjustable.

19. The collection device according to claim 1, wherein the connector has a hook shape.

20. The collection device according to claim 1, wherein the connector is configured to receive and secure the second end of the elongated portion.
